(19) United States
(12) Patent Application Publication
(10) Pub. No.: US 2020/0051041 A1
(43) Pub. Date: Feb. 13, 2020

(54) SYSTEM AND METHOD FOR ARBITRATING A BLOCKCHAIN TRANSACTION

(71) Applicant: Hajoon Ko, Cambridge, MA (US)

(72) Inventor: Hajoon Ko, Cambridge, MA (US)

(21) Appl. No.: 16/148,519

(22) Filed: Oct. 1, 2018

(30) Foreign Application Priority Data
Aug. 10, 2018 (KR) 10-2018-0093841

(51) Int. Cl. G06Q 20/06; G06Q 20/38

(52) U.S. Cl. CPC G06Q 20/065; H04L 9/3236; G06Q 20/3827; G06Q 20/3829

(57) ABSTRACT

A system and method for arbitrating a blockchain transaction enables a sender node and a receiver node to perform a transaction with a payment contract, and also record the transaction in the blockchain to protect the sender and receiver node from unfair practices; by preventing the receiver node from transferring received payments until a dispute resolution period that is preset by the sender node has expired. The transaction and payment contract are conducted with a payment condition-checking smart code that executes the transaction only when predetermined conditions have been met. The sender node and the receiver node can elect arbitrator nodes through a delegated proof of stake process. The arbitrator nodes verify the transaction, and review submitted arbitration applications. The arbitrator nodes create an arbitrator report that is also recorded in the blockchain. If dissatisfied with the arbitration, a subsequent arbitration, or an offline dispute resolution node can be requested.

### FIELD OF THE INVENTION

The present invention relates generally to a system and method for arbitrating a blockchain transaction. More so, the present invention relates to a system and method that enables a sender node and a receiver node to perform a blockchain-recorded transaction that protects both parties by preventing the receiver node from transferring received payments until a dispute resolution period that is preset by the sender node has expired; whereby the transaction utilizes a payment condition-checking smart code that executes the transaction only when predetermined conditions have been met; and further allows a plurality of arbitrator nodes to execute and verify the transaction, and review arbitration requests from the sender node or the receiver node.

### BACKGROUND OF THE INVENTION

The following background information may present examples of specific aspects of the prior art (e.g., without limitation, approaches, facts, or common wisdom) that, while expected to be helpful to further educate the viewer as to additional aspects of the prior art, is not to be construed as limiting the present invention, or any embodiments thereof, to anything stated or implied therein or inferred thereupon.

It is known in the art that a blockchain is a growing list of records, called blocks, which are linked using cryptography. Each block contains a cryptographic hash of the previous block, a timestamp, and transaction data. With a blockchain, many people can write entries into a record of information, and a community of users can control how the record of information is amended and updated. Also, in the blockchain, each data record is protected against tampering and revisions.

Typically, blockchains are used with public ledgers of transactions, where the record is enforced cryptographically. This invention enables transactions to be private by encrypting the contents of the transaction and only users or entities that have the key to the transaction can view the transaction.

Generally, blockchain technology was developed as a way of providing a publicly transparent and decentralized ledger that is configured to track and store digital transactions in a publicly verifiable, secure, and hardened manner to prevent tampering or revision. Data stored on a blockchain can only be safely removed through a fork of the original. The blockchain's immutable nature makes editing, removing, accessing or modifying personal data stored on a blockchain very difficult, if not impossible. More importantly, the inability to remove personal data puts blockchain technology at odds with many privacy laws and principles.

At the core of blockchain technology is the establishment of a peer-to-peer network which guarantees data integrity without involving a centrally trusted authority. As blockchain management nodes guarantee high data security by managing blocks in a distributed manner based on global consensus, blockchain services don't suffer the problem of a single point of failure. All transaction records in a blockchain are publicly accessible by all blockchain users. In addition, legitimacy of transaction records can be verified by all blockchain participants, which removes the necessity for verification from central parties. Blockchain-based services can also lower the service fees incurred by traditional intermediate entities in various social use cases, such as banking, real estate contracts, notarization, and billing.

Generally, banking services are where the blockchain can be actively spread and applied as an emerging new paradigm of financial system with advantages such as high security, transparency of transaction history and cost reduction by using the decentralized ledger technology of the blockchain. Further, the possibility of using blockchain in the manufacturing and distribution sectors is also expanding. In particular, a blockchain can be applied to Internet of Things (IoT) to record real-time flows of information among ‘things’. The blockchain can help guarantee the transparency of supply chains. Public sectors can leverage blockchain to automatically and securely manage land registry, issue e-Residency, and manage voting services.

In many instances, blockchain technology can benefit various social/entertainment businesses. Introduction of blockchain in the music and contents industry can prevent copyright infringement in the industry and can lead to fundamental changes in the distribution and profit structure. The blockchain can become a secure platform for other services such as car sharing, car renting, real estate transactions, gift certificates, and reward points.

The blockchain is classified into two types. One is a public (or permissionless) blockchain in which anyone can participate as blockchain management nodes. Classical examples of public blockchains are Bitcoin or Ethereum. The other type of blockchain is a private (or permissioned) blockchain in which only pre-authorized entities can become management nodes. Examples of such blockchains include Hyperledger Fabric and Corda.

In a blockchain, each block contains the block's noninvertible hash value, a digital signature of its creator, and list of transactions, and the noninvertible hash value of the previously generated block. It is hardly possible to fabricate a past block, because doing so requires fabricating all blocks between the newest block and the target block to fabricate, all of which are connected and protected by noninvertible hash values.

As blocks in a blockchain is difficult to fabricate, it is also difficult to revert any transaction within a block once an agreement about each new block is reached among blockchain management nodes. However, this property causes problems. If an attacker succeeds in stealing a victim wallet's private key, the attacker can transfer all coins in the victim wallet to the attacker's wallet, and thereafter recursively re-send coins to other attacker-controlled wallets to make it almost impossible to track and retrieve stolen coins from the attacker. In other cases, the sender might have accidentally sent coins to a receiver. But in such a case, existing Bitcoin-like blockchain does not provide any way for the sender to retrieve his/her mistakenly remitted coins except for the case that the receiver honestly agrees to send back coin to the sender.

One strawman solution is to newly introduce arbitrator(s) into the blockchain to securely abort completed transactions. However, this brings in the issue of trust in arbitrators. Also, if the receiver already spent coins to another transactions and the receiver's wallet balance becomes zero, it's impossible for the original sender to get the coins back from the receiver's zero-balanced wallet.

Other proposals have involved blockchain systems and methods that authorize transactions. The problem with these blockchain and cryptocurrency transaction methods is that they do not provide arbitrators to determine the validity of the transaction. Also, they do not have a smart contract that executes the transaction, only after conditions have been met. Even though the above cited blockchain transaction verification systems and methods meet some of the needs of the market, a system and method for arbitrating a blockchain transaction that enables a sender node and a receiver node to perform a blockchain-recorded transaction that protects both parties by preventing the receiver node from transferring received payments until a dispute resolution period that is preset by the sender node has expired; whereby the transaction utilizes a payment condition-checking smart code that executes the transaction only when predetermined conditions have been met; and further allows a plurality of arbitrator nodes to execute and verify the transaction, and review arbitration requests from the sender node or the receiver node, is still desired.

### SUMMARY

Illustrative embodiments of the disclosure are generally directed to a system and method for arbitrating a blockchain transaction. The system and method enables a sender node and a receiver node to perform a transaction with a payment contract, and also record the transaction in the blockchain to protect the sender and receiver node from unfair practices; by preventing the receiver node from transferring received payments until a dispute resolution period that is preset by the sender node has expired.

The transaction and payment contract are conducted with a payment condition-checking smart code that executes the transaction only when predetermined conditions have been met. For example, a digital service has been stored and signed off, in an external storage server. The sender node and the receiver node can elect a plurality of arbitrator nodes through a delegated proof of stake process to verify the transaction, and review arbitration requests.

The arbitrator nodes create an arbitrator report that is also recorded in the blockchain by the mining node. If the sender node and receiver node are dissatisfied with the arbitration, a subsequent arbitration can be requested, or the arbitrator nodes can pass the dispute to an offline dispute resolution node.

In some embodiments, the method may comprises an initial Step of creating a payment contract between a sender node and a receiver node, the payment contract comprising a payment condition-checking smart code.

A Step comprises setting, by the sender node, a dispute resolution period.

The method may further include a Step of transacting a trade between the sender node and the receiver node.

A Step comprises executing, by a mining node, the payment condition-checking smart code upon request by the sender node, or the receiver node, or both.

A Step is, if the execution result of the payment condition-checking smart code is true, executing payment to the receiver node.

Another Step may include selecting, by the sender node and the receiver node, a plurality of arbitration nodes.

In some embodiments, a Step comprises submitting, by the sender node or the receiver node, an arbitration application.

A Step may include determining, by the arbitration nodes, the validity of the transaction.

The method may also include a Step of submitting, by the sender node or the receiver node, upon disagreement with the determination, a subsequent arbitration application.

In another aspect, the transaction comprises trading a digital content service for a cryptocurrency.

In another aspect, the method further comprises a step of storing the digital content service in an external storage server.

In another aspect, the execution result of the payment condition-checking smart code is true when the digital content service is stored in the external storage server and signed by the receiver node before the dispute resolution period terminates.

In another aspect, the method further comprises a step of sending the payment contract to a mining node.

In another aspect, the method further comprises a step of creating, by the mining node, a payment contract block.

In another aspect, the arbitration application is submitted to the mining node.

In another aspect, the arbitration application is transferred from the mining node to the arbitrator nodes after an arbitration block is created.

In another aspect, the method further comprises a step of generating, by the arbitrator nodes, an arbitration report.

In another aspect, the method further comprises a step of requesting, by the arbitrator nodes, the mining node to create an arbitration report block.

In another aspect, the payment contract includes at least one of the following: a contract number, a sender node public key, a receiver node public key, a payment condition-checking smart code, a number of arbitrator nodes to be involved in case of dispute, a sender node signature, a receiver node signature, a payment contract hash value, and a contract user data.

In another aspect, the payment contract is encrypted.

In another aspect, the step of selecting a plurality of arbitration nodes, further comprises selecting the arbitration modules through a delegated proof of stake process.

In another aspect, the subsequent arbitration comprises more arbitration nodes than the prior arbitration application.

In another aspect, the method further comprises the step of acquiring, by the arbitrator nodes, additional information from the sender node and the receiver node.

In another aspect, the method further comprises the step of passing the arbitration application to an offline dispute resolution node.

In another aspect, the method further comprises a step of paying, by the sender node and the receiver node, a fee for submitting the arbitration application.

In another aspect, the fee increases for the subsequent arbitration application.

In another aspect, the mining node operates as the sender node, the receiver node, or both the sender and receiver nodes.

One objective of the present invention is to protect blockchain transactions by providing data security and integrity through use of a plurality of independent arbitrators that can review the transaction.

Another objective is to not allow the receiver node's wallet to transfer the newly received cryptocurrency to another wallet until the end of the sender node's preset dispute resolution period.

Another objective is to provide a safer digital asset transaction environment through arbitrator nodes that review the transactions.

Another objective is to securely revoke or modify already processed transactions in dispute.

Another objective is to securely store the digital serves and cryptocurrency involved in the transaction in an external storage server.

Another objective is to protect the transaction contract through encryption.

Another objective is to record the payment contract and arbitration record in a block in the blockchain.

Another objective is to remit transactions between trading parties based on payment condition-checking smart codes.

Another objective is to allow the sender node and receiver node to request a new arbitration if they are not satisfied with the first arbitration.

Another objective is to provide fairer arbitration for transactions in which disputes exist,

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart of an exemplary method for arbitrating a blockchain transaction, in accordance with an embodiment of the present invention;

FIG. 2 illustrates a diagram for the architecture of an exemplary system for arbitrating a blockchain transaction, in accordance with an embodiment of the present invention;

FIG. 3 illustrates a diagram of an exemplary a payment and arbitration protocol for the system for arbitrating a blockchain transaction, in accordance with an embodiment of the present invention; and

FIG. 4 illustrates a diagram of an exemplary system for arbitrating a blockchain transaction that uses payment condition-checking smart code which includes an external storage server, in accordance with an embodiment of the present invention.

Like reference numerals refer to like parts throughout the various views of the drawings.

### DETAILED DESCRIPTION OF THE INVENTION

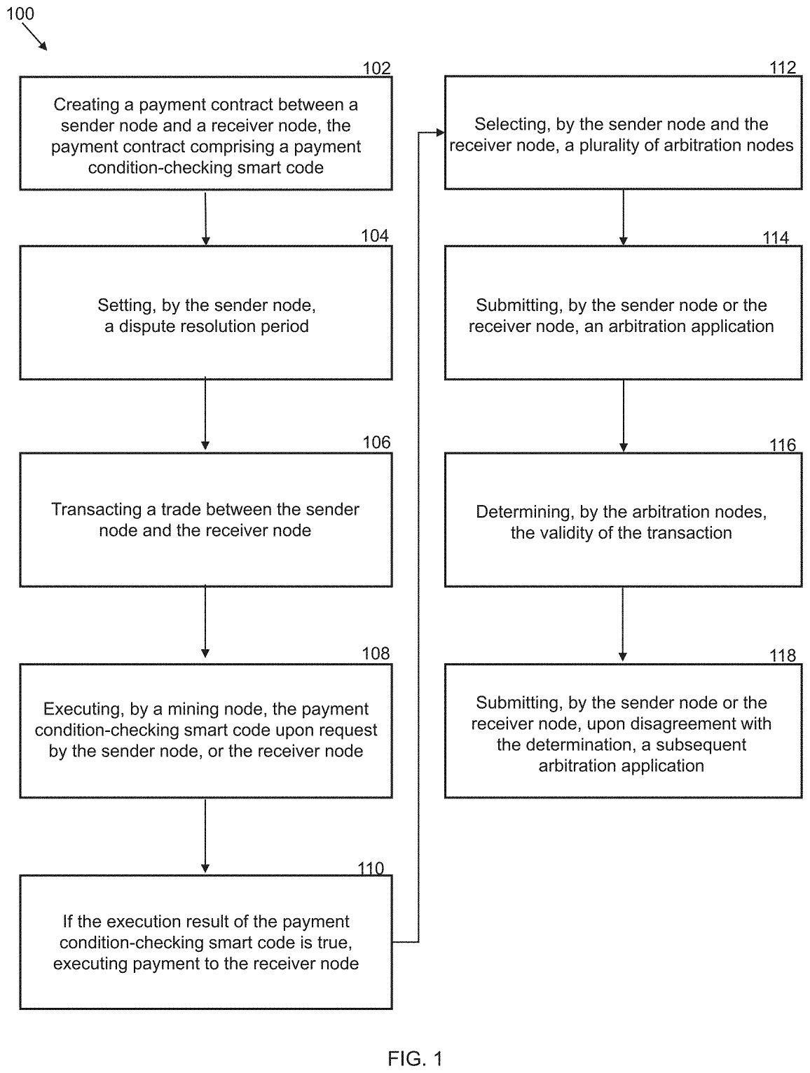

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 200 and method 100 for arbitrating a blockchain transaction is referenced in FIGS. 1-4. System 200 and method 100 provides a blockchain-recorded transaction that is executed upon preconditions being met, and arbitrated upon if any party is dissatisfied with the transaction.

System 200 and method 100 create a blockchain environment in which a sender node 202 and a receiver node 204 can draft a payment contract S210 for performing a transaction. A mining node 206 records the payment contract in the blockchain. The transaction may include a swap of a digital service for a cryptocurrency, coin, or simply a fiat currency known in the art. The transaction is performed by a sender node 202 that sends the cryptocurrency payment to the receiver node 204 in exchange for a digital content service, such as writing a document, translation, design/image/advertisement production, and software development. However in other embodiments, non-digital services or products may be transacted. The payment may be standard cash, check, or bank wire transfer.

The sender node 202 presets a dispute resolution period, during which the receiver node 204 cannot transfer the cryptocurrency payment to another wallet, until the transaction is approved and executed. This helps to protects both the sender node 202 and the receiver node 204 from unfair practices by preventing the receiver node 204 from transferring received payments until the dispute resolution period has expired.

Both the transaction, and the payment contract S210 are conducted with a payment condition-checking smart code that is written into the contract. The payment condition-checking smart code may include a software code that executes the transaction, only when predetermined conditions have been met. For example, the payment condition-checking smart code executes when a digital service has been stored and signed off, in an external storage server 210.

The sender node 202 and the receiver node 204 elect a plurality of arbitrator node 208s through a delegated proof of stake process. The arbitrator node 208s verify the transaction, and review an arbitration application from the sender and receiver node 204s. After reviewing the arbitration application, the arbitrator node 208s create an arbitrator report, which is also recorded in the blockchain by the mining node 206. If the sender node 202 and receiver node 204 are dissatisfied with the arbitration, a subsequent arbitration can be requested, or the arbitrator node 208s can pass the dispute to an offline dispute resolution node.

FIG. 1 illustrates a flowchart of an exemplary method 100 for amending a blockchain transaction through arbitration. In some embodiments, an initial Step 102 comprises creating a payment contract between a sender node and a receiver node, the payment contract comprising a payment condition-checking smart code. The payment contract S210 may be encrypted to enhance security.

Another Step may include sending the encrypted payment contract to a mining node, where the mining node can create a payment contract block in the blockchain. This serves to record the transaction for subsequent review by all parties involved. In some embodiments, the payment contract may include, without limitation, a contract number, a sender node public key, a receiver node public key, a payment condition-checking smart code, a number of arbitrator nodes to be involved in case of dispute, a sender node signature, a receiver node signature, a payment contract hash value, and a contract user data.

A Step 104 comprises setting, by the sender node, a dispute resolution period. Sender node 202 presets a dispute resolution period, during which the receiver node cannot transfer the cryptocurrency payment to another wallet, until the transaction is approved and executed. The dispute resolution period allows time for the sender node and arbitration nodes to verify the veracity of the digital service work, service, or product being offered, before making payment.

The method may further include a Step 106 of transacting a trade between the sender node and the receiver node. The transaction is performed by sender node 202, who sends the cryptocurrency payment to receiver node 204 in exchange for a digital content service. The digital content service may include, without limitation, writing a document, translation, design/image/advertisement production, and software development.

Another Step may include storing the digital content service in an external storage server. External storage server 210 is a possible use case of leveraging the blockchain to store, and record, the digital service created by the receiver node for the sender node. When the sender node and the receiver node exchange cryptocurrency for digital contents, for example, the external storage server can be used to store the result. Since the blockchain has a characteristic that its work history is stored, the capacity of the work may exceed several gigabytes when the work is a digital media type. In one non-limiting embodiment, external storage server 210 is a remote server, a database, a cloud, and a network.

In this case, it is difficult to continuously accumulate such large data in the blockchain. Therefore, the work containing large data is temporarily stored in the storage server until the transaction is completed, and only one-way hash value of the data of the completed work is stored in the block. This is because it is possible to identify the work data that a receiver node transfers to the sender node by only checking the small hash value.

A Step 108 comprises executing, by a mining node, the payment condition-checking smart code upon request by the sender node, or the receiver node, or both. Mining node 206 manages the blocks in the blockchain, creating a blockchain record of the transaction, payment contract, and arbitration application and report. If the payment condition-checking smart code is not specified, the payment is executed immediately because there is no condition. The payment condition-checking smart code may include a software code that executes the transaction, only when predetermined conditions have been met. In this manner, the mining node creates blocks and organizes details of the transaction. In some embodiments, mining node operates as the sender node, the receiver node, or both the sender and receiver nodes.

If the payment condition-checking smart code is such that the sender node requests a receiver node for a job, the payment is approved only when this payment condition-checking smart code is satisfied. For example, if the digital file such as a document or an image is a work result, the payment condition-checking smart code may check if the resulting work stored in a particular external storage server and signed by receiver node before the deadline specified in the payment contract.

In one non-limiting embodiment, sender node 202 and receiver node 204 request execution of the payment condition-checking smart code at the same time as sending a new payment contract. Thus, if a mining node executes the payment condition-checking smart code and its result is true, only one block recording both facts can be created. Unlike the case where execution of the payment condition-checking smart code is separately requested, it is possible to shorten the approval time of the payment transaction because the payment contract and the approval of the payment transaction are recorded in one block.

A Step 110 teaches, if the execution result of the payment condition-checking smart code is true, executing payment to the receiver node. This ensures that the conditions of sender node 202 are satisfied before receiver node 204 has the freedom to transfer cryptocurrency or other funds to an external wallet or money storage unit.

Another Step 112 may include selecting, by the sender node and the receiver node, a plurality of arbitration nodes. Arbitration nodes 208 review an arbitration application and determine a resolution. Arbitration nodes 208 have the option of reversing the transaction, amending the transaction, and approving the transaction. In one possible embodiment, the decision of arbitration nodes 208 is binding on sender node 202 and receiver node 204.

In some embodiments, a Step 114 comprises submitting, by the sender node or the receiver node, an arbitration application. The arbitration application contains the details of the problems or issues experienced by the sender and receiver nodes. The arbitration application is sent to the arbitration nodes for review. However, the arbitration modes may also send the arbitration application to the mining node to form an arbitration application block in the blockchain. This records the arbitration specifics, and issues the parties have with the transaction. The sender and receiver nodes may pay a fee for submitting the arbitration application.

A Step 116 may include determining, by the arbitration nodes, the validity of the transaction. Another Step may include generating, by the arbitrator nodes, an arbitration report. The arbitration report includes the ruling of arbitration nodes 208. In one non-limiting embodiment, mining node 206 receives the arbitration report for purposes of creating an arbitration report block. The arbitration report block allows for securely recording the arbitration of the transaction.

Method 100 may also include a Step 118 of submitting, by the sender node or the receiver node, upon disagreement with the determination, a subsequent arbitration application. In one non-limiting embodiment, the fee increases for the subsequent arbitration application. The fee may be paid by either the sender node 202, receiver node 204, or both nodes 202, 204.

Another Step may include passing the arbitration application to an offline dispute resolution node. If the conflict between sender node 202 and receiver node 204 persists, the arbitrator nodes 208 may decide to pass the case to offline authorities, such as a court or dispute resolution centers, rather than revoking or modifying the problematic payment contract by themselves.

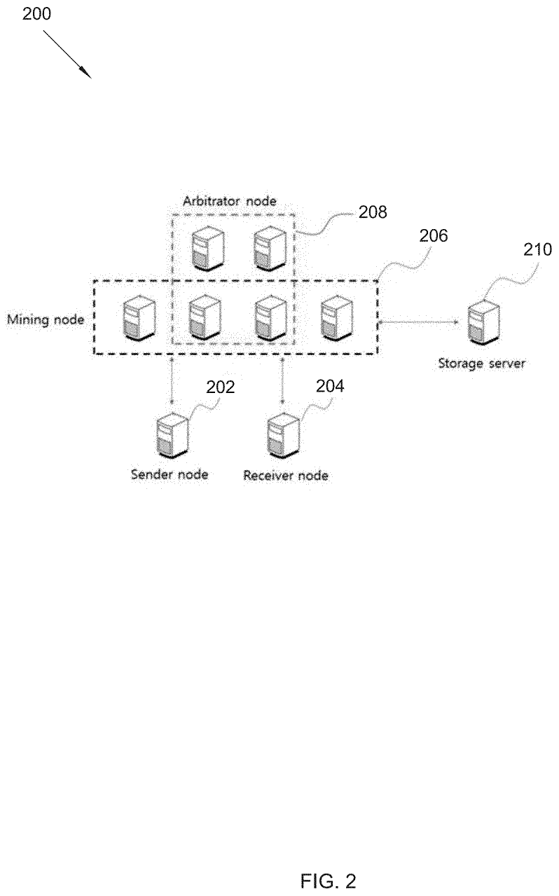

FIG. 2 references the architecture for the system 200. In one non-limiting embodiment, system 200 includes a sender node 202, a receiver node 204, a mining node 206 and an arbitrator node 208. In another embodiment, sender node 202 and receiver node 204 create a bank-like transaction that simply transfers money, or create a digital contract-based transaction which involves exchange of digital contents and/or cryptocurrency. However in other embodiments, sender node 202 and receiver node 204 are the nodes of the parties performing transactions in the blockchain. Sender node 202 and receiver node 204 can also be a mining node 206 for block-mining, or can be independent nodes other than mining nodes 206.

In one non-limiting embodiment, sender node 202 may be a digital job requester. In another non-limiting embodiment, receiver node 204 can be a worker, in which case the sender node 202 requests a job and sends cryptocurrency to a receiver node 204 in reward. Mining node 206 is a node that creates a block and manages the blockchain.

Mining node 206 provides a resource for managing a blockchain service and receives digital cryptocurrency in exchange for creating a block, which is referred to as mining. Mining nodes 206 create blocks and organize transaction details in the block; the methods include Proof of Work (PoW), Proof of Stake (PoS), a Distributed Proof of Stake (DPoS).

Mining node 206 creates a block at the request of sender node 202 or receiver node 204 and records a payment contract including the payment condition-checking smart code in the block. Thereafter, mining node 206 executes the coin-sending condition smart code written in the payment contract upon a request from sender node 202 or receiver node 204, and cryptocurrency is transferred to a receiver node 204 when the smart code's result value is true. If the coin-sending condition (or the smart code) is not specified within a payment contract, the coin will be immediately sent to receiver node 204 as soon as mining node 206 appends the block to the blockchain.

In one non-limiting embodiment, arbitrator nodes 208 work to resolve the dispute between sender node 202 and receiver node 204. Arbitrator node 208 may or may not be elected among mining nodes 206. Arbitrator node 208 can be elected by blockchain users in the way of PoS or DPoS. In practice, arbitrator nodes 208 should have good reputation or trust from users in order to be elected and maintain their position. When sender node 202 and receiver node 204 create a payment contract, they can set the number of arbitrator nodes 208 to be involved in case of a dispute.

One or more arbitrator nodes 208 are either randomly assigned or preselected based on the agreement between sender node 202 and receiver node 204 in order to arbitrate each dispute between a sender node and a receiver node, whose decision will be either cancelling, modifying, or confirming the already processed payment contract. This means that arbitrator nodes 208 can, based on voting, collectively make an overriding decision to either cancel or modify the amount of transferred coin between sender node 202 and receiver node 204.

Dispute resolution follows the majority decision of arbitrator nodes 208 participating in the arbitration. Before making their decision, they can ask the sender and receiver node to describe their situation more in detail and require submit personal identifications to their identity. If needed, the arbitrators may hold a mini trial with the sender and receiver via video chats. If the conflict between the sender and receiver still persists, the arbitrators could decide to pass the case to offline authorities, such as a court or dispute resolution centers, rather than revoking or modifying the problematic payment contract by themselves.

If sender node 202 or receiver node 204 is not satisfied with the result of the arbitration requests another arbitration, more arbitrator nodes 208 than the number of the previous arbitrator nodes 208 will be selected to recursively resolve the dispute. The arbitration fee paid to each arbitration node 208 increases as the dispute resolution request grows recursively. For each arbitration, the fee is deducted from the wallet of the arbitration requestor, which is either a sender, a receiver, or both.

When sender node 202 and receiver node 204 exchange cryptocurrency for digital contents, for example, an external storage server 210 can be used to store the result, such as digital service. Since the blockchain has a characteristic that its work history is stored, the capacity of the work may exceed several gigabytes when the work is a digital media type; in this case, it is difficult to continuously accumulate such large data in the blockchain. Therefore, the work containing large data is temporarily stored in storage server 210 until the transaction is completed, and only one-way hash value of the data of the completed work is stored in the block. This is because it is possible to identify the work data that receiver node 204 transfers to sender node 202 by only checking the small hash value.

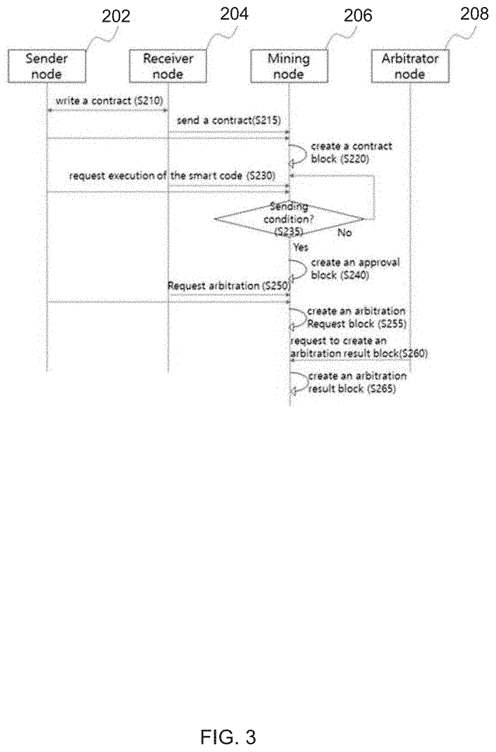

FIG. 3 references a payment and arbitration protocol of the OAS Secure Pay blockchain. Sender node 202 and receiver node 204 create a payment contract S210 and transmit it to mining node 206 S215. Payment contract S210 includes the contract number, the sender node's public key, a receiver node's public key, the payment condition-checking smart code, the number of arbitrator nodes to be involved in case of dispute, the sender node's signature, a receiver node's signature, the payment contract's hash value, and contract contract's user data. The contents of the contract can be encrypted with a cryptographic key that sender node 202 and receiver node 204 agree to share.

FIG. 3 references the payment and arbitration protocol for system 200. In one non-limiting embodiment, mining node 206 first creates a block including the payment contract S220. After creating a block, mining node 206 executes the payment contract's payment condition-checking smart code upon request from sender node 202 or receiver node 204, S235. Mining node 206 creates a new block S240 which records the smart code execution result (either true of false). If the result is true, it implies that the payment has been approved and the cryptocurrency have been completely transferred from sender node 202 to receiver node 204.

Sender node 202 and receiver node 204 may request execution of the payment condition-checking smart code at the same time as sending a new contract. If mining node 206 executes the payment condition-checking smart code and its result is true, only one block recording both facts can be created. Unlike the case where execution of the payment condition-checking smart code is separately requested, it is possible to shorten the approval time of the payment transaction because the payment contract and the approval of the payment transaction are recorded in one block.

In one non-limiting embodiment, mining node 206 can make a consensus on new blocks based on the methods such as PoW, PoS or DPoS. A plurality of different payment contracts from different sender and receiver nodes can be recorded in one block.

The conditions for execution of payment are recorded in the payment condition-checking smart code. The payment condition-checking smart code can be written in computer programming languages such as C, Java, or Go. If the payment condition-checking smart code is not specified, the payment is executed immediately because there is no condition. If the payment condition-checking smart code is such that sender node 202 requests receiver node 204 for a job, the payment is approved only when this payment condition-checking smart code is satisfied. For example, if the digital file such as a document or an image is a work result, the payment condition-checking smart code may check if the resulting work stored in a particular external storage server 210 and signed by receiver node 204 before the deadline specified in the payment contract.

Sender node 202 and receiver node 204 may change the agreement details if the payment condition-checking smart code even after their payment contract is created, provided both parties agree to do so. This change is done by requesting mining node 206 to create of a block which includes the contract change notification.

The contract change notification includes the original payment contract's number, the original contract's hash value, the contract change notification's number, the sender node public key, a receiver node public key, the payment condition-checking smart code, the number of arbitrator nodes, a receiver node signature, the change contract hash value, and the changed contract details. The details of the contract change notification can be optionally encrypted with a cryptographic key that sender node 202 and receiver node 204 agree and share.

The cryptocurrency received from receiver node 204 vests to receiver node 204 definitively after a predetermined arbitration period. Therefore, receiver node 204 cannot retransmit the received coin to another node until the arbitration period passes.

If a dispute occurs, sender node 202 or receiver node 204 can apply for arbitration to arbitrator node 208 or mining node 206 within the arbitration period from the time when payment is completed.

The dispute resolution period is set for each wallet when a wallet is created by sender and receiver nodes 202, 204 participating in a blockchain and cannot be changed afterwards. The dispute resolution period may be determined by time and date or set as the number of blocks additionally created after transaction such as 10 or 100 blocks. The dispute resolution period of each payment contract follows the dispute resolution period set in the wallet of sender node 202.

Sender node 202, when creating its own wallet, can set its wallet's dispute resolution period to be short to allow receiver nodes to use their received cryptocurrency immediately after receiving them, in which case the sender node's wallet may become more insecure in case its wallet gets compromised. On the other hand, if the sender node sets a particular dispute resolution period, it is possible to prevent a malicious attacker cannot immediately retransmit cryptocurrency after stealing out cryptocurrency from the sender's wallet. An arbitration application is completed by creating a dispute resolution form and sending it to mining node 206. Mining node 206 creates a block including arbitration application form S255, which can be read by any arbitrator nodes 208.

The arbitration application includes the original payment contract's number, the arbitration application's number, the requesting (sender or receiver) node's public key, the requesting (sender or receiver) node's signature, the public key list of the arbitrator nodes as many as the arbitrator nodes to be involved, user data describing the dispute, and a decryption key. The application can be optionally encrypted with the public keys of the arbitrator nodes.

Arbitrator nodes 208 are elected by the blockchain participants' voting, by a DPOS method. Mining node 206 may become also an arbitrator node 208. Remitting node 202 and collecting node 204 can specify the identity of arbitrator nodes they will use in case of dispute in advance when creating the payment contract. Otherwise, they can select them when creating an arbitration application.

Arbitrator node 208 arbitrates the dispute between sender node 202 and receiver node 204 and transmits a report of the arbitration result to mining node 206, S260. The arbitration report includes the arbitration application number to be arbitrated, the hash value of the arbitration application, the arbitration report number, the signature of the arbitrator nodes, the changes on the original payment contract, user data describing the arbitration result, and an optional decryption key. The changed payment contract details are encrypted with the public keys of the sender node and a receiver node to guarantee confidentiality.

Mining node 206 creates a block including the arbitration report including the result details S265, thereby completing the arbitration procedure. The arbitration report can make an overriding decision to cancel the original payment contract without any intervention of sender node 202 and a receiver node 204, or to confirm to vest the transferred cryptocurrency to receiver node 204 in accordance with the arbitration result. The arbitration report, in order to have its effect, should be signed by a majority of arbitrator nodes 208 involved.

In one non-limiting embodiment, arbitrator nodes 208 complete the arbitration by requesting mining node 206 to create a block including the arbitration report that is the result of the dispute resolution. A single block created by mining node 206 may include multiple independent payment contracts, contract change notifications, arbitration applications, and arbitration reports, each of which is created by independent sender, receiver, or arbitration nodes.

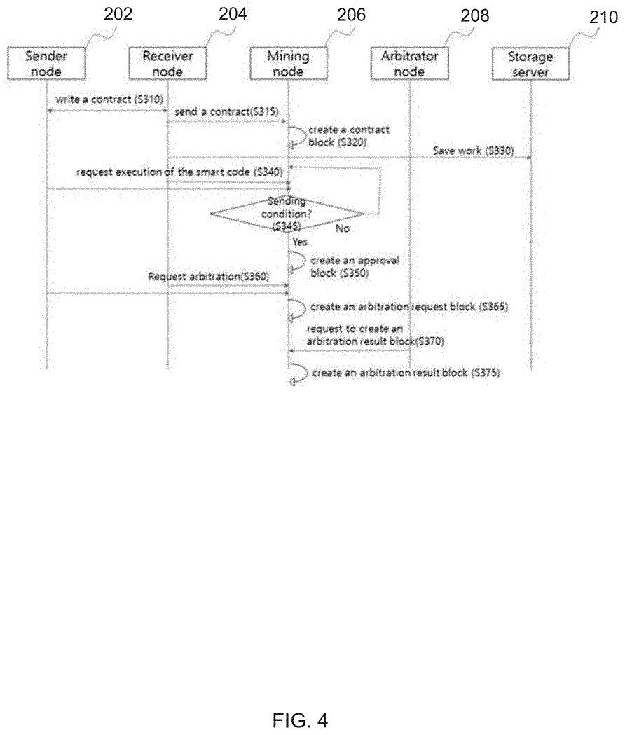

FIG. 4 describes an example of using payment condition-checking smart code which includes an external storage server 210. Involving an external storage server is a possible use case of leveraging OAS Secure Pay's blockchain service in order to store digital work created by the receiver node. Sender node 202 and receiver node 204 create a payment contract S310 and send it to mining node 206 S315, and then the mining node 206 creates a block including the payment contract S320.

Payment contract includes the contract number, the sender node's public key, the receiver node's public key, the payment condition-checking smart code, the number of arbitrator nodes to be involved in case of dispute, the sender node's signature, the receiver node's signature, the payment contract's hash value, and the contract details. If necessary, the contract details can be encrypted with a cryptographic key.

As this example is the case where sender node 202 requests receiver node 204 for some work, payment is executed only when the execution result of the payment condition-checking smart code is true. An example of this code may be that it checks if the work is stored in a particular external storage server and signed by the receiver node before the deadline specified in the payment contract. Receiver node 204 fulfills these requirements S330.

Later in time, when sender node 202 or receiver node 204 requests the payment condition-checking smart code to be executed S340, mining node 206 executes the payment condition-checking smart code included in their payment contract S345. Mining node 206 creates a block that records the execution result S350. If the execution result is true, cryptocurrency specified in the payment contract are treated to be transferred from the sender node to the receiver node.

Receiver node 204 or sender node 202 discontent with the work or payment result can request dispute resolution by creating an arbitration application and sending it to mining node 206 (S360). Thereafter, mining node 206 creates a block which includes the arbitration application S365. Then, one or more arbitrator nodes 208 who are specified in the arbitration application collectively create an arbitration report and send to mining node S370; and mining node 206 creates a block which includes the arbitration report. In some cases, sender node 202 or receiver node 204 can request arbitration any time between the creation of payment contract and the end of the sender node's wallet's preset arbitration period.

Sender node 202 or receiver node 204, which is not satisfied with the result after the dispute resolution, can request arbitration recursively. If an arbitration is re-requested, the number of arbitrator nodes 208 should be selected more than before and the arbitration fee for each arbitrator grows higher. The fee is deducted from the wallet of the arbitration requestor, which is either a sender, a receiver, or both.

As described above, users of system 200 can benefit from a safer digital asset transaction environment through arbitrator nodes, and thereby securely revoke or modify already processed transactions in dispute.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A computer-implemented method for arbitrating a blockchain transaction, the method comprising:
creating a payment contract between a sender node and a receiver node, the payment contract comprising a payment condition-checking smart code;
setting, by the sender node, a dispute resolution period;
setting the dispute resolution period to prevent a malicious attacker from immediately retransmitting a cryptocurrency payment after stealing a cryptocurrency payment from a sender's wallet;
wherein the dispute resolution period, once set, cannot be modified, such that if a wallet key is stolen in a malicious attack, the malicious attack cannot modify the dispute resolution period to a zero day and immediately unlock funds;
wherein the sender node presets the dispute resolution period, during which the receiver node cannot transfer the cryptocurrency payment to the sender's wallet until a transaction is approved and executed;
transacting a trade between the sender node and the receiver node;
executing, by a mining node, the payment condition-checking smart code upon request by the sender node, or the receiver node, or both;
if the execution result of the payment condition-checking smart code is true, executing payment to the receiver node;
selecting, by the sender node and the receiver node, a plurality of arbitration nodes;
submitting, by the sender node or the receiver node, an arbitration application;
determining, by the arbitration nodes, the validity of the transaction;
wherein the dispute resolution period allows time for the sender node and a plurality of arbitration nodes to verify a veracity of a digital work being offered before making a payment;
determining the dispute resolution period by at least one of a time, date or set of the number of blocks additionally created after a transaction;
wherein a dispute resolution period of the payment contract follows the dispute resolution period set in the wallet of the sender node; and
submitting, by the sender node or the receiver node, upon disagreement with the determination, a subsequent arbitration application.

2. The method of claim 1, wherein the transaction comprises trading a digital content for a cryptocurrency.

3. The method of claim 2, further comprising a step of storing the digital content in an external storage server.

4. The method of claim 3, wherein the execution result of the payment condition-checking smart code is true when the digital content is stored in the external storage server and signed by the receiver node before the dispute resolution period terminates.

5. The method of claim 1, further comprising a step of sending the payment contract to a mining node.

6. The method of claim 5, further comprising a step of creating, by the mining node, a payment contract block.

7. The method of claim 6, wherein the arbitration application is submitted to the mining node.

8. The method of claim 7, wherein the arbitration application is transferred from the mining node to the arbitrator nodes after an arbitration block is created.

9. The method of claim 8, further comprising a step of generating, by the arbitrator nodes, an arbitration report.

10. The method of claim 9, requesting, by the arbitrator nodes, the mining node to create an arbitration report block.

11. The method of claim 1, wherein the payment contract includes at least one of the following: a contract number, a sender node public key, a receiver node public key, a payment condition-checking smart code, a number of arbitrator nodes to be involved in case of dispute, a sender node signature, a receiver node signature, a payment contract hash value, and a contract user data.

12. The method of claim 1, wherein the payment contract is encrypted.

13. The method of claim 1, wherein the step of selecting a plurality of arbitration nodes, further comprises selecting the arbitration modules through a delegated proof of stake process.

14. The method of claim 1, wherein the subsequent arbitration comprises more arbitration nodes than the prior arbitration application, wherein a number of arbitrators involved increases with a repeated arbitration request and an amount of an arbitration fee increases with the repeated arbitration request.

15. The method of claim 1, further comprising the step of acquiring, by the arbitrator nodes, additional information from the sender node and the receiver node.

16. The method of claim 1, further comprising the step of passing the arbitration application to an offline dispute resolution node.

17. The method of claim 1, further comprising a step of paying, by the sender node and the receiver node, a fee for submitting the arbitration application.

18. A computer-implemented method for arbitrating a blockchain transaction, the method comprising:
creating an encrypted payment contract between a sender node and a receiver node, the encrypted payment contract comprising a payment condition-checking smart code,
whereby the encrypted payment contract includes at least one of the following: a contract number, a sender node public key, a receiver node public key, a payment condition-checking smart code, a number of arbitrator nodes to be involved in case of dispute, a sender node signature, a receiver node signature, a payment contract hash value, and a contract user data;
sending the encrypted payment contract to a mining node; creating, by the mining node, a payment contract block; setting, by the sender node, a dispute resolution period;
setting the dispute resolution period to prevent a malicious attacker from immediately retransmitting a cryptocurrency payment after stealing a cryptocurrency payment from a sender's wallet
wherein the dispute resolution period, once set, cannot be modified, such that if a wallet key is stolen in a malicious attack, the malicious attack cannot modify the dispute resolution period to a zero day and immediately unlock funds;
wherein the sender node presets the dispute resolution period, during which the receiver node cannot transfer the cryptocurrency payment to the sender's wallet until a transaction is approved and executed;
transacting a trade between the sender node and the receiver node, the transaction comprising trading a digital content for a cryptocurrency;
storing the digital content in an external storage server;
executing, by a mining node, the payment condition-checking smart code upon request by the sender node, or the receiver node, or both;
if the execution result of the payment condition-checking smart code is true, executing payment to the receiver node, whereby the execution result of the payment condition-checking smart code is true when the digital content is stored in the external storage server and signed by the receiver node before the dispute resolution period terminates;
selecting, by the sender node and the receiver node, a plurality of arbitration nodes through a delegated proof of stake process;
submitting, by the sender node or the receiver node, an arbitration application;
determining, by the arbitration nodes, the validity of the transaction;
wherein the dispute resolution period allows time for the sender node and a plurality of arbitration nodes to verify a veracity of the digital work being offered before making a payment;
determining the dispute resolution period by at least one of a time, date or set of the number of blocks additionally created after a transaction;
wherein the dispute resolution period of a payment contract follows the dispute resolution period set in the wallet of the sender node:
generating, by the arbitrator nodes, an arbitration report;
requesting, by the arbitrator nodes, the mining node to create an arbitration report block; and
submitting, by the sender node or the receiver node, upon disagreement with the determination, a subsequent arbitration application, the subsequent arbitration comprising more arbitration nodes than the prior arbitration application.

19. The method of claim 18, further comprising the step of passing the arbitration application to an offline dispute resolution node.

20. A computer-implemented system for arbitrating a blockchain transaction, the system comprising:
an encrypted payment contract for a transaction generated between a sender node and a receiver node, the transaction comprising trading a digital content for a cryptocurrency, the encrypted payment contract further comprising a payment condition-checking smart code;
an external storage server storing the digital content, or the cryptocurrency, or both;
a payment contract node created by a mining node, whereby the executing, by the payment condition-checking smart code is executed by the mining node upon request by the sender node, or the receiver node, or both;
a dispute resolution period set by the sender node or the receiver node, the dispute resolution period being for the transaction,
wherein the dispute resolution period is set to prevent a malicious attacker from immediately retransmitting cryptocurrency payment after stealing the cryptocurrency payment from the sender's wallet;
wherein the dispute resolution period, once set, cannot be modified, such that even if a wallet key is stolen in a malicious attack, the malicious attack cannot modify the dispute resolution period to a zero day and immediately unlock funds;
wherein the sender node presets the dispute resolution period, during which the receiver node cannot transfer the cryptocurrency payment to another wallet until a transaction is approved and executed;
whereby if the execution result of the payment condition-checking smart code is true, payment is executed to the sender node, whereby the execution result of the payment condition-checking smart code is true when the digital content is stored in the external storage server and signed by the receiver node before the dispute resolution period terminates;
an arbitration application submitted by the sender node or the receiver node;
a plurality of arbitration nodes selected by the sender node and the receiver node to arbitrate the arbitration application, whereby the arbitration nodes determine the validity of the transaction;
wherein the dispute resolution period allows time for the sender node and the plurality of arbitration nodes to verify a veracity of a digital work being offered before making payment;
determining, the dispute resolution period by at least one of a time, date or set of the number of blocks additionally created after a transaction;
wherein the dispute resolution period of each payment contract follows the dispute resolution period set in the wallet of the sender node;
an arbitration report generated b the arbitrator nodes;
an arbitration report block requested, by the arbitrator nodes, for the mining nodes to generate; and
a subsequent arbitration application submitted by the sender node or the receiver node, upon disagreement with the determination, the subsequent arbitration comprising more arbitration nodes than the prior arbitration application.
